(19) United States
(12) Patent Application Publication
(10) Pub. No.: US 2024/0167883 A1
(43) Pub. Date: May 23, 2024

(54) DEVICE FOR STORING AN OBJECT OR SUBSTANCE AND MONITORING DEVICE FOR TEMPERATURE AND/OR RADIATION

(71) Applicant: dot.COOL Group Inc., Lewes, DE (US)

(72) Inventors: Robert BIALAS, Berlin (DE); Amin ZAYANI, Berlin (DE)

(73) Assignee: dot.COOL Group Inc., Lewes, DE (US)

(21) Appl. No.: 18/388,831

(22) Filed: Nov. 11, 2023

(30) Foreign Application Priority Data
Nov. 21, 2022 (DE) 10 2022 212 392.1

(51) Int. Cl. G01J 5/14; A61J 1/20; G01J 5/03; G01J 5/12; G01J 5/22; G01K 1/024

(52) U.S. Cl. CPC G01J 5/14; A61J 1/20; G01J 5/03; G01J 5/22; G01K 1/024; A61J 2200/72; G01J 2005/123; G01K 2213/00

(57) ABSTRACT

The invention relates to a device (1) for storing an object or a substance, in particular a medication, having a container (2, 20) with a container space for storing the object or the substance and having a monitoring device (5), which comprises a first sensor (6) for detecting measurement data and a processing device (10) for determining a irradiation input and/or heat input and/or the temperature and/or a temperature profile of the object or the substance or of the container space using the detected measurement data, wherein the first sensor is a sensor (6) for detecting electromagnetic radiation, in particular a semiconductor sensor or a thermopile.

The text below is a translation of the German patent application with the reference No. 10 2022 212 392.1, which has been filed on Nov. 21, 2022 with the German patent office and which hereby is incorporated by reference in this application.

The invention is in the field of metrology and medical technology and can be applied especially in the storage and transport of medications.

In many different areas of life, the need to store a substance or an object regularly arises and, in doing so, monitoring certain parameters of the substance, the object or the environment. Often, the need arises to monitor a temperature in order to detect or prevent the stored goods from exceeding or falling below certain temperature thresholds.

In particular, the problem can arise with medications or sensitive objects, such as those with electronic functions. Drugs in particular, such as insulin or other biologic medications, are often very temperature-sensitive and can irreversibly change important properties when temperature thresholds are exceeded or undershot.

For this reason, the present invention is based on the task of creating a storage device which allows the temperature of stored goods and/or irradiation it is exposed to to be monitored particularly reliably.

This task is fulfilled by the features of the invention by a storage device according to patent claim 1. Possible implementations are presented in the subclaims. Further, the task according to the invention is solved by a monitoring device for a container for storing an object or a substance, subclaims also indicating possible implementations for this solution. In addition, the invention relates to a system comprising a medication-delivering pump as well as a device for storing a medication and a monitoring device.

Accordingly, the invention in one implementation relates to a device for storing an object or a substance, in particular a medication, having a container with a container space for storing the object or the substance and having a monitoring device which comprises a first sensor for recording measurement data and a processing device for determining an irradiation input and/or heat input and/or the temperature and/or a temperature profile of the object or the substance or the container space using the recorded measurement data, characterized in that the first sensor is a sensor for detecting electromagnetic radiation, in particular a semiconductor sensor or a thermopile.

In some cases, the sensor for measuring radiation in a certain wavelength range may be a dosimeter or a sensor comprising a dosimeter, which can measure the ionization by radiation and an accumulation of electric charges, like a Metal-oxide-semiconductor field-effect transistor dosimeter, or a thermoluminescent dosimeter, a Quartz fiber dosimeter, a Geiger tube dosimeter or a chemical substance reacting to radiation in a well determined way like a film badge dosimeter, where the film can be read out by an optical measurement process. All the listed types of dosimeters may be read out periodically or constantly by an automatic device to keep track of the amount of accumulated radiation.

It has been established that in many cases that using a temperature sensor alone is not sufficient, or in some cases not necessary, to properly monitor the temperature of the stored goods.

The physical mechanisms that are important for reaching a certain temperature are heat conduction, convection and radiation, wherein radiation may comprise heat radiation as well as radiation in other wavelength ranges. In different situations, different ones of these mechanisms are dominant. For example, if a storage container is exposed to a certain level of radiation, such as infrared radiation, ultraviolet radiation or electromagnetic radiation in the visible range, this can be relevant for the energy input and also for an achieved temperature of the stored goods. Furthermore, it has been found that some medications including insulin are also sensitive to destruction or disfunctionalization by radiation directly, that is, by damaging and/or denaturing of elements of the substance, like molecules, by radiation directly. Alternatively, or in addition to this immediate damaging by radiation, of course a damaging of a substance like a medication by high temperatures may occur. If, for example, it is assumed that an item or substance, for example insulin, will remain undamaged for a certain period of time at normal ambient temperatures, the occurrence of electromagnetic radiation, such as infrared radiation, UV radiation or light irradiation in the visible range, can very quickly lead to an unacceptable rise in local temperature. It is then not necessary to measure an actual temperature of the goods or the storage container in order to detect or predict a temperature rise with sufficient accuracy.

A prominent use case is, for example, the stay of a person with a storage device in a cool environment with strong solar radiation, specifically skiing in the mountains, where an insulin container for feeding an insulin pump is worn on the body. In this case, the container according to the invention may also be integrated in a medication/insulin pump or an injector pen. The person often does not feel any heating of the container, but the insulin heats up very quickly due to solar radiation and can be damaged by both the influence of heat as well as radiation. With the storage device according to the invention, the radiation intensity can be determined by a sensor and a certain temperature increase can be predicted, and in some embodiments, the amount of radiation which is absorbed by the object or substance in the container can be determined, whereupon an alarm can be triggered if a critical threshold is reached either by the temperature or by the accumulated radiation or both. A temperature measurement may be provided with the storage device, but it may also be dispensable if, for example, it can simply be assumed that the container has assumed the body temperature of the wearer at the beginning of the irradiation. The temperature and the temperature curve can then be determined and predicted differentially solely by detecting the solar radiation.

In some cases, a prediction model may include the heat input by radiation, heat conduction and potentially also the loss of heat by convection, conduction and radiation over time to the container and the object or substance. Thereby, a temperature development can be predicted. Further, the accumulated radiation in a spectral range, like in the IR, UV or visible ranges and also in the range of particle radiation, that is x-ray, alpha-beta or gammy radiation may be taken into account as well as any combination of these ranges, for example a combination of UV and visible range, IR and visible range or all three ranges or any of these ranges combined with one of the x-ray, and the particle radiation ranges may be measured by a sensor and also summed up to determine potential damages caused in the object or in the substance which is in the container. If the container is combined with a tubing or hose or catheter for transportation of a medication to or from the container, the influence of heat and radiation to a substance/medication while it is in the tube, hose or catheter may also be assessed and included in the determination.

Another application arises, for example, when shipping or transporting sensitive substances or components, where it must be ensured along a transport chain that a certain limit temperature is not exceeded. Here, too, an initial temperature corresponding to a usual room temperature can be assumed and incident radiation can be measured to estimate a temperature or predict a temperature curve with sufficient accuracy.

The use of semiconductor elements as radiation sensors for different wavelength ranges is basically known. Filters can be used to limit the measurement of radiation by the sensor to certain wavelength ranges.

However, thermopiles can also be used to detect radiant energy. The radiated radiation energy is then largely converted into heat/thermal energy, except for the reflected part, and this can be measured by a temperature increase. The intensity of radiation may then also be determined from the temperature rise taking into consideration heat conduction and radiation by the object or substance/medication. For this purpose, the temperature of a thermopile exposed to radiation is measured with a combination of thermocouples.

It may also be provided that the first sensor is set up to detect electromagnetic radiation in a wavelength-sensitive manner.

Various types of sensors for detecting electromagnetic radiation are known, for example photodiodes that are sensitive in the visible, UV or infrared range.

Since the absorption of radiation by the container the storage device and the stored goods is in many cases wavelength-dependent, an estimate of the temperature or a temperature profile can be made much more accurately if one or more sensors are used that enable the detection or determination of the radiation intensity in one or more specific wavelength ranges. One possible solution here is to detect a spectrum, but in many cases it may be sufficient to select a particular sensor or sensors that are sensitive in one or more particular wavelength region(s). The effect of radiation in certain wavelength ranges on the container and the stored goods can be tested to achieve a calibration, i.e. a parameter determination for a later temperature estimation.

A possible embodiment of the invention may provide that the monitoring device has, in addition to the first sensor one or two temperature sensors for measuring the temperature in the container and/or on the outside of the container or in the vicinity of the container, and in that the processing device is set up to process, in addition to the measurement data of the first sensor, also the measurement data of the temperature sensor(s) for determining a temperature and/or a temperature profile.

In this constellation, the measurement of the actual temperature or temperatures is possible on an ongoing basis, as is the measurement of a radiation intensity. It can then be continuously calculated by the processing device how the measured radiation intensity affects the temperature of the goods to be stored, so that accurate forecasts of the temperature trend, for example a rate of change, of the temperature for the immediate future can also be generated on the basis of a currently measured radiation intensity.

Due to the fact that absolute temperatures are also continuously recorded, a predicted temperature curve is well supported. The parameters linking the measured radiation intensity with a temperature increase, i.e. the sensitivity of the temperature of the goods to be stored with respect to the radiation intensity, can be constantly updated by continuously recording the temperature(s) and the radiation intensity to update the temperature forecast and make it more reliable.

Another possible embodiment of the invention may provide that the processing device for determining the irradiation input and/or a temperature and/or a temperature profile is arranged to predict a time period, after which a determined amount of radiation has been absorbed by the object or substance and/or a temperature profile of the object or the substance or the container space.

Therein, the amount of radiation that has been absorbed by the object or substance can be defined as the amount in a certain wavelength range. The processing device can use either measured data from a radiation sensor or, if necessary, measured temperature data or both. For example, the amount of irradiation which has been absorbed by the substance or object may be assessed on the basis of a measured temperature rise of an object outside the container or a temperature rise of a temperature sensor outside or inside the container.

Furthermore, it may be provided that the processing device for determining a temperature and/or a temperature profile is arranged to determine and/or predict a rate of change of the temperature of the article or substance or the container space. The rate of change of the temperature is a quantity that is very useful for generating an alarm to warn of over-heating of the good to be stored.

It may also be provided that the processing device for determining a temperature and/or a temperature profile or a radiation input has a module which determines the exceeding of a predetermined threshold of irradiation absorbed by the object or substance or of the temperature or a rate of change of the temperature.

The temperature threshold can be sensibly determined taking into account the nature of the goods to be stored and the safety requirements.

Another possible embodiment of the invention may provide that that the processing device for determining a temperature and/or a temperature profile is connected to an alarm module for generating an alarm signal.

Thus, an acoustic, mechanical or optical alarm or an electronic alarm signal can be emitted by the alarm module, which is a part of the monitoring device.

It may further be provided that the monitoring device has both a first sensor for detecting radiation and at least one temperature sensor, and in that the processing device also has a self-learning device which continuously relates the measured data of the radiation intensity and the measured temperature data to one another as a function of time and forms rules therefrom.

The self-learning device can form structures that assign a rate of change of temperature to certain absolute temperatures and values of a radiation intensity, respectively. This rate of change can depend, for example, on the permeability of the container to radiation, but also on so-called PCM materials that exhibit a phase transition in sensible temperature ranges, so that at these temperatures an irradiation of energy does not lead directly to a temperature increase, but initially to a phase transition of the PCM materials connected to the container. Only after the phase transition does the temperature change further. The device can learn the relationships and rules in several passes by recording the temperature behavior and the radiation intensity.

Another implementation of the invention may be that at least one boundary wall of the container consists of a flexible material, in particular that the container is designed as a bag.

Such a container is particularly easy to wear on the body for storing a medication. For example, the container may be a pouch or a pillow or pad.

In addition to a storage device of the type described above, the invention also relates to a monitoring device for a container having a container space for storing an object or a substance, in particular a medication, the monitoring device comprising a first sensor for detecting measurement data and a processing device for determining the irradiation input and/or heat input and/or temperature and/or a temperature profile of the object or the substance or of the container space using the detected measurement data, wherein the first sensor is a sensor for detecting electromagnetic radiation, in particular a semiconductor sensor or a thermopile.

Such a monitoring device can also be used or sold without a container. It can then be used in a specific situation together with a container or directly with an item to be stored and, if necessary, also with other elements such as a medication-delivering pump or an injector pen and, in particular, if it is equipped with a learning system, it can adapt to existing conditions easily, quickly and reliably. The monitoring device may comprise any sensor for particle, ex-ray, UV, IR or visible radiation which has in detailed been described above.

In one possible embodiment of the monitoring device it comprises both a first sensor for detecting radiation and one or two temperature sensors and a processing device connected thereto for determining the temperature and/or a temperature profile of the object or the substance or the container space using the detected measurement data, and in particular a self-learning device which is set up to continuously correlate, as a function of time, the measurement data of the radiation intensity and/or the measured temperature data and to determine therefrom rules for predicting a temperature profile or a period of time after which a determined amount of radiation has been absorbed by the object or substance.

Another embodiment of the monitoring device is characterized by an energy supply device comprising an energy storage and/or harvesting device for converting mechanical, thermal or radiation energy into electrical energy. The electrical energy can be used to power the monitoring device and specifically the processing device.

Due to the fact that the storage device may be used for a long time without a connection to an energy supply network, the functioning of, for example, the processing device with electric current must be enabled over a longer period of time if possible. This is possible with a battery supply, but also by extracting energy from the environment with a harvesting device and using it for operation.

Finally, the invention also relates to a system with an injection device, in particular a medication-delivering pump, a syringe or an injector pen, and with a monitoring device as described above and in particular with a device for storing a medication for injection.

Such a system with a medication-delivering pump or injector pen can be used universally and without interference if the invention can ensure that the drug, for example insulin, is not overheated or overcooled or exposed to high amounts of radiant energy over a prolonged period of time.

In the following, the invention is shown by means of examples in figures of a drawing and explained in the following. Thereby shows

FIG. 1: a section of a human body in a schematic view showing an upper arm and a system worn there with a medication-delivering pump and a storage device,

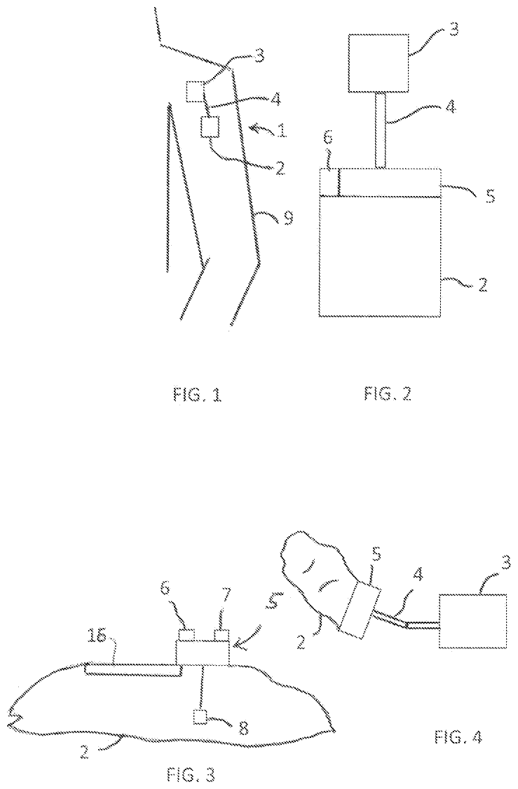

FIG. 2: in enlarged form, schematic of the medication-delivering pump and storage device,

FIG. 3: schematic of a storage device with a container and a monitoring device,

FIG. 4: a bag-shaped container with a monitoring device,

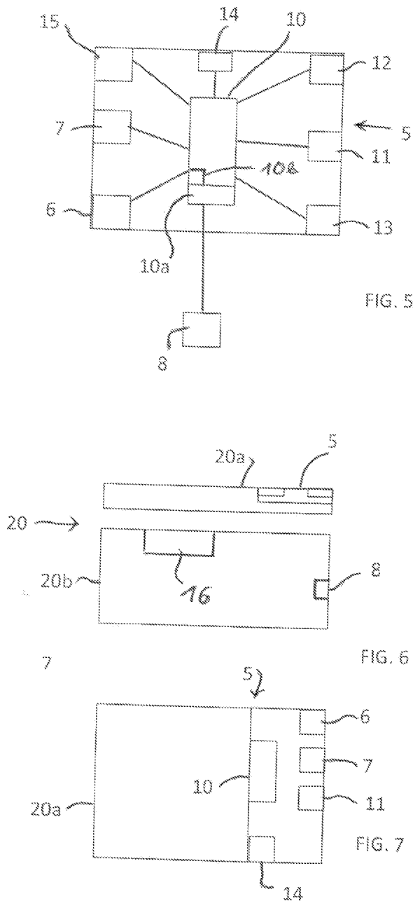

FIG. 5: A monitoring device schematically with components,

FIG. 6: a fixed transport container with a lid and a monitoring device, and

FIG. 7: the lid of the transport container from FIG. 6 schematically in a view from above.

FIG. 1 schematically shows a portion of a human body with a storage device 1 for storing an item, in this case a medication, with a container 2 and a metering pump 3 for administering the medication through the skin of the body. The storage device 1 is attached to the upper arm 9 of a human being on the skin. The container 2 is connected to the dosing pump 3 by means of a flexible line 4, but a container may also be integrated into a pump or an injector pen. The drug can be delivered by the dosing pump from the container through the flexible line or conduit 4 into the body.

The determination of influence of raised temperature or radiation to the medication may take into account the influence which is taken by temperature or radiation on the line 4 or on the medication while it is in the line 4.

FIG. 2 shows the container 2, the flexible line 4 and the medication-delivering pump somewhat enlarged. A monitoring device 5 with a radiation sensor 6 is arranged on the surface of the container 2, and the monitoring device 5 may be attached directly to the container 2. The monitoring device and/or the sensor may in one potential implementation be attached in a removable manner to the container or directly to a medication-delivering pump/injector pen.

FIG. 3 shows a monitoring device 5 with three sensors 6, 7, 8, namely a radiation sensor 6 in the form of a semiconductor photodiode, a first temperature sensor 7 outside the bag-shaped container 2 and a second temperature sensor 8 inside the container 2. The monitoring device contains further elements which are described in detail in connection with FIG. 5. A PCM material 16 is further shown to abut the wall of the bag/container 2 or to form part of the container wall.

FIG. 4 shows the connection of a container 2 in the form of a bag, which carries a monitoring device 5, to a metering pump 3 through a flexible fluid line 4.

Instead of a medication-delivering pump, which may be implantable, an injector pen can also be used, which can itself also function as a container for a drug and which carries a monitoring device of the type described with a radiation sensor.

FIG. 5 shows a monitoring device 5 with a processing device connected to a radiation sensor 6 in the form of a semiconductor photodiode, another radiation sensor 15, and a first temperature sensor 7 and a second temperature sensor 8. The two radiation sensors 6, 15 may have their sensitivity in different wavelength ranges, so that each of the sensors detects a different radiation, the different radiations in different wavelength ranges contributing differently to the energy input into the container.

The processing device 10 is also connected to an energy storage device 11 in the form of a battery or rechargeable accumulator for supplying electrical energy.

Furthermore, the processing device is connected to two energy harvesting elements in the form of a photo element 12 and a thermocouple 13, which converts temperature differences into voltages. The energy harvesting elements can directly supply the processing device 10 with energy or serve to charge the accumulator 11. The sensor 6, which is used to detect electromagnetic radiation, can also contribute to the power supply of the processing device if it is, for example, a photodiode or other semiconductor radiation sensor.

The processing device 10 is also connected to an alarm module 14, via which an alarm signal can be output in acoustic, visual, haptic (e.g. vibration) or electronic form under certain conditions.

This may be provided, for example, when certain temperature thresholds are foreseeably exceeded, or a temperature forecast indicates a certain risk of exceeding a temperature, or when certain rates of temperature change are reached or exceeded.

If, for example, PCM elements 16 are provided in or on the container 2 whose material exhibits a phase transition in the temperature range usually passed through, for example between 2 degrees Celsius and 25 degrees Celsius, it is important for good functioning of the processing device that this is taken into account when predicting the temperature profile. In particular, if a temperature sensor is provided in addition to the radiation sensor, appropriate calculation rules can be provided to the processing device. For example, the energy required for the phase transition can be taken into account when summing up the detected radiation energy if the temperature of the container is below the phase transition temperature at the start of the irradiation. The processing device can then predict a temperature profile taking into account the mass and phase transition temperature of a PCM-material. There may also be a self-learning device 10a integrated into the processing device 10, which picks up the temperature behavior of the container through sufficient training passes and forms rules for it. In FIG. 5, 10b indicates a module for monitoring an alarm-triggering parameter, for example a temperature threshold or a threshold value of the rate of temperature change.

In another application, FIG. 6 shows a side view of a container 20 which is designed as a rigid, insulated shipping container and which has a lid 20a and a box 20b. A monitoring device 5 is integrated into the lid 20a, comprising a processing device 10, a radiation sensor 6 and a temperature sensor 7 on the outside of the lid, as well as an alarm module 14 and a battery 11. The processing device 10 is also connected to a temperature sensor 8 inside the box 20a, for example via a wireless connection, to allow easy removal of the lid at any time. The temperature sensor 8 may be a passive sensor that does not consume power, such as a surface wave sensor or other transponder.

Also shown in FIG. 6 is an element 16 made of a PCM-material having a phase transition at a temperature between 5 degrees Celsius and 25 degrees Celsius and integrated into a wall of the box 20b.

1. Device (1) for storing an object or a substance, in particular a medication, having a container (2, 20) with a container space for storing the object or the substance and having a monitoring device (5) which comprises a first sensor (6) for recording measurement data and a processing device (10) for determining an irradiation input and/or heat input and/or the temperature and/or a temperature profile of the object or the substance or the container space using the recorded measurement data,
characterized in that
the first sensor is a sensor (6) for detecting electromagnetic radiation, in particular a semiconductor sensor or a thermopile.

2. Device according to claim 1,
characterized in that
the first sensor (6) is set up to detect electromagnetic radiation in a wavelength-sensitive manner.

3. Device according to claim 1,
characterized in that
the monitoring device (5) has, in addition to the first sensor (6), one or two temperature sensors (7, 8) for measuring the temperature in the container (2, 20) and/or on the outside of the container or in the vicinity of the container, and in that the processing device (10) is set up to process, in addition to the measurement data of the first sensor, also the measurement data of the temperature sensor(s) for determining a temperature and/or a temperature profile.

4. Device according to claim 1,
characterized in that
the processing device (10) for determining the irradiation input and/or a temperature and/or a temperature profile is arranged to predict a time period, after which a determined amount of radiation has been absorbed by the object or substance and/or a temperature profile of the object or the substance or the container space.

5. Device according to claim 1,
characterized in that
the processing device (10) for determining a temperature and/or a temperature profile is arranged to determine and/or predict a rate of change of the temperature of the object or substance.

6. Device according to claim 1,
characterized in that
the processing device (10) for determining a temperature and/or a temperature profile has a module (10b) which determines the exceeding of a predetermined threshold of irradiation absorbed by the object or substance or of the temperature or a rate of change of the temperature and/or in that the processing device (10) for determining a temperature and/or a temperature profile is connected to an alarm module (14) for generating an alarm signal.

7. Device according to claim 1,
characterized in that
the monitoring device has both a first sensor (6) for detecting radiation and at least one temperature sensor (7, 8), and in that the processing device (10) also has a self-learning device (10a) which continuously relates the measured data of the radiation intensity and the measured temperature data to one another as a function of time and forms rules therefrom.

8. Device according to claim 1,
characterized in that
at least one boundary wall of the container (2) consists of a flexible material, in particular when the container is designed as a bag.

9. Monitoring device (5) for a container having a container space for storing an object or a substance, in particular a medication, the monitoring device (5) comprising a first sensor (6) for detecting measurement data and a processing device (5) for determining the irradiation input and/or heat input and/or temperature and/or a temperature profile of the object or the substance or of the container space using the detected measurement data, characterized in that the first sensor is a sensor for detecting electromagnetic radiation, in particular a semiconductor sensor or a thermopile.

10. Monitoring device according to claim 9,
characterized in that
it comprises both a first sensor (6) for detecting radiation and one or two temperature sensors (7, 8) and a processing device (10) connected thereto for determining the temperature and/or a temperature profile of the object or the substance or the container space using the detected measurement data, and in particular a self-learning device (10a) which is set up to continuously correlate, as a function of time, the measurement data of the radiation intensity and/or the measured temperature data and to determine therefrom rules for predicting a temperature profile or a period of time after which a determined amount of radiation has been absorbed by the object or substance.

11. Monitoring device according to claim 9,
characterized by an energy supply device comprising an energy storage (11) and/or a harvesting device (12, 13) for converting mechanical, thermal or radiation energy into electrical energy.

12. System with an injection device, in particular a medication-delivering pump (3), a syringe or an injector pen, and with a monitoring device according to claim 9 and in particular with a device (1) for storing a medication for injection.
